(19) United States
(12) Patent Application Publication
(10) Pub. No.: US 2007/0156504 A1
(43) Pub. Date: Jul. 5, 2007

(54) Providing feminine care product recommendations tailored to the composition and rheological properties of vaginal discharge

(75) Inventors: Nancy J. Myers, Neenah, WI (US); Paula Lynn McNiel, Neenah, WI (US); Joyce Ann Damico, Neenah, WI (US); Cheryl Ann Mocadlo, New London, WI (US); Candace Dyan Krautkramer, Neenah, WI (US); Charles Keely, Town of Clayton, WI (US); Sandy Grigg, Berlin, WI (US)

Correspondence Address: SENNIGER POWERS (KCC), ONE METROPOLITAN SQUARE, 16TH FLOOR, ST LOUIS, MO, 63102, US

(73) Assignee: Kimberly-Clark Worldwide, Inc., Neenah, WI (US)

(21) Appl. No.: 11/322,686

(22) Filed: Dec. 30, 2005

(51) Int. Cl. G07G 1/00

(52) U.S. Cl. 705/10; 705/3

(57) ABSTRACT

Identifying attributes of feminine care products corresponding to the biological and rheological properties of vaginal discharge of a consumer based on predefined correlations. Aspects of the invention obtain vaginal discharge data of the consumer and identify the attributes to the consumer to aid the consumer in making a purchase decision regarding the feminine care products.

### BACKGROUND

Existing systems recommend personal care products such as teas, vitamins, and cosmetics to a woman depending on the stage in life of the woman. For example, U.S. Pat. No. 5,947,302 discloses a method for providing a system of feminine hygiene products for use by individuals. The method includes collecting information from a female consumer regarding her menstrual cycle using a computer, selecting a system of feminine hygiene products based upon the information collected where the system contains at least one tampon and one sanitary napkin. The method further includes a step of providing information back to the consumer identifying the products that make up the selected system.

Further, U.S. Pat. Nos. 5,865,322 and 5,839,585 disclose a method for dispensing absorbent articles for use by individuals with a dispensing device containing at least two different types of absorbent articles and a means for allowing an individual to select one or more types of the absorbent articles in the dispensing device.

These previous systems, however, use a limited set of generic information entered by the consumer for selecting the system of hygiene products for the consumer.

### SUMMARY

Embodiments of the invention provide personal care product recommendations adapted for a particular biological life stage of a woman's life. In one embodiment, the product recommendations are based on biological and rheological properties (e.g., a description) of the vaginal discharge of the consumer that are dependent in part upon the fluid differences or body characteristics of the consumer. Hormonal differences also affect the fluid properties of the consumer.

Aspects of the invention realign the product development and marketing of feminine care products using a biological model that incorporates the biological life stage or life event differences that occur in females and affect the fluid properties of menses, postmenopausal discharge, and other vaginal secretions.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating a consumer interacting with one embodiment of the invention.

FIG. 2 is a flow chart illustrating exemplary operation of one embodiment of the invention.

FIG. 3 is an exemplary embodiment of the invention in which a consumer interacts with a kiosk to obtain a product recommendation.

Appendix A provides test data illustrating different performance of feminine care products as a function of fluid with varied viscoelastic properties.

Corresponding reference characters indicate corresponding parts throughout the drawings.

### DETAILED DESCRIPTION

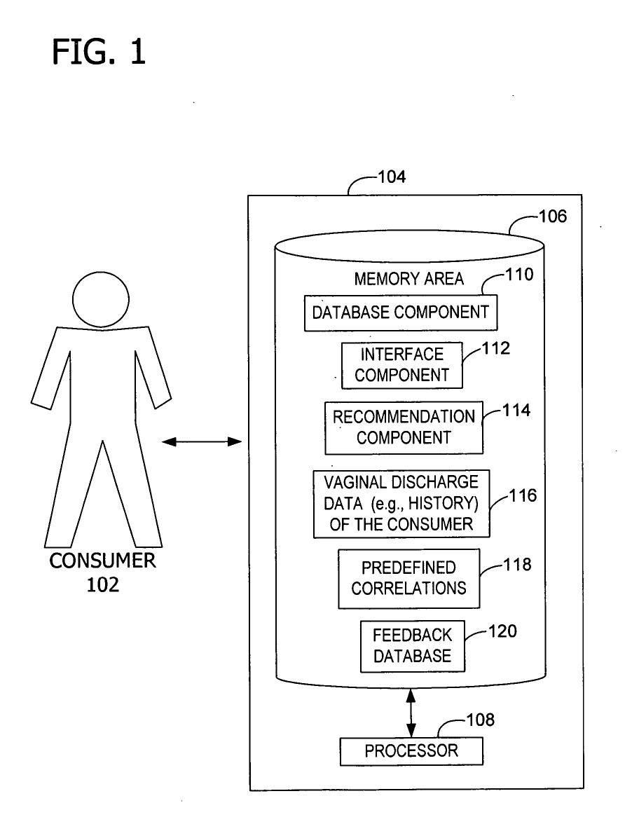

Referring first to FIG. 1, embodiments of the invention obtain information related to vaginal secretions or other discharge of a consumer 102, customer, or other user, and provide product recommendations based on predefined correlations 118 between vaginal discharge data and product attributes. In one embodiment, vaginal discharge data includes, but is not limited to, direct data (e.g., clots, gushes, infection) and implied data (e.g., age, hormonal contraception). Using the differences in fluid properties (e.g., identified at or after each specific biological life stage or event), aspects of the invention provide for understanding, educating, and communicating with women about personal care product recommendations adapted for a vaginal discharge history, personal history, or a particular biological life stage or life event in a woman's life. Further aspects of the invention aid in determining product design, dimensions, materials, surfactants, and additives (e.g., skin wellness ingredients, fluid modifiers).

Other systems provide personal care product education tailored to the consumer 102 based on physical characteristics of the consumer 102. For example, see commonly owned, co-pending U.S. patent application Ser. No. 11/026,845, filed Dec. 30, 2004, entitled “INTERACTING WITH CONSUMERS TO INFORM, EDUCATE, CONSULT, AND ASSIST WITH THE PURCHASE AND USE OF PERSONAL CARE PRODUCTS,” hereby incorporated by reference, as well as commonly owned, co-pending U.S. patent application Ser. No. 10/325,440, filed Dec. 20, 2002 by Hantke et al., entitled “METHOD FOR AIDING CONSUMERS IN SELECTION OF THE PROPER SIZE OF INTERLABIAL ABSORBENT ARTICLES” (published as US20040122745A1), also hereby incorporated by reference. Embodiments of the present invention, however, provide scientific criteria for the use of biological life stage or life event differences that occur in females (e.g., hormonal changes) and affect the fluid properties of menses, postmenopausal discharge, and other vaginal secretions or discharge. The properties of the vaginal discharge may be observed, determined, and/or specified by the consumer 102. These physiological differences are used to design, develop, manufacture, and market feminine care products that specifically meet the needs at each biological life stage or life event such as puberty, pregnancy, child birth, and menopause.

Referring again to FIG. 1, the consumer 102 interacts with an exemplary system 104 of the invention to obtain a personal care product recommendation. The system 104 includes a processor 108 and one or more computer-readable media such as a memory area 106. The memory area 106 stores computer-executable components such as a database component 110, an interface component 112, a recommendation component 114, vaginal discharge data 116 of the consumer 102, and the predefined correlations 118 between predefined vaginal discharge data and attributes of feminine care products, and a feedback database 120.

The database component 110 maintains the predefined correlations 118 between predefined vaginal discharge data and attributes of feminine care products. The interface component 112 obtains the vaginal discharge data 116 of the consumer 102 regarding a biological property and a rheological property of vaginal discharge from the consumer 102. The recommendation component 114 identifies one or more of the attributes of the feminine care products corresponding to the obtained vaginal discharge data 116 of the consumer 102 based on the maintained predefined correlations 118. The interface component 112 further provides one or more of the identified attributes to the consumer 102 for use in selecting one of the feminine care products.

The vaginal discharge data in the predefined correlations 118 includes, for example, data obtained empirically or experimentally and is mapped to attributes of the feminine care products. The attributes generally relate to the materials, additives, absorbent system design, shape, and features of the feminine care products. Exemplary material attributes include the quantity, quality, type and properties (e.g., absorbency, stiffness, curl) of fiber, quantity, placement, shape, chemistry, properties and quality of super absorbent material (S.A.M.), type, location of and quantity of surfactant or additives, type and properties of body side liner (BSL), type of absorbent (e.g., airlaid, airformed, coform, bonded carded web, spunlace, spunbond) and type, quantity, and location of odor management components. Exemplary shape attributes include the length, width, resiliency, flexibility, and thickness of the product. Other attributes describe, for example, pad structure (e.g., wings, curved sides, elastic sides) and/or the presence of embossing and apertures in the feminine care products. Menses modifier additives alter the characteristics of menses to improve the performance of feminine care products, as shown in commonly owned U.S. Pat. No. 6,867,344 to Potts et al., hereby incorporated by reference. Red blood cell lysing agents disclosed therein include GLUCOPON 220, an octylpolyglycoside available from Henkel Corporation, Ambler, Pa., MASILE SF-19, an alkoxylated polysiloxane available from PPG Industries, Inc., Specialty Chemicals Division, Gurnee, Ill., nonionic surfactant LAURETH 7, an alkoxylated alcohol available from Heterene, Inc., Paterson, N.J., nonionic LAURETH 4, an alkoxylated alcohol available from Heterene, Inc., nonionic PPG 5-Laureth 5, an alkoxylated alcohol available from Henkel Corporation, amphoteric surfactant DERIPHAT 160S, an alkyl-substituted amino acid available from Henkel/Cospha, Ambler, Pa., anionic surfactant sodium laurel sulfate, an alkyl sulfate available from Henkel, amphoteric MACKAM 15-L, an alkyl substituted amino acid available from McIntyre Group, University Park, Ill., anionic MACKANATE LM-40, a sulfosuccinate available from McIntyre Group, anionic STANDOPOL SH124-3, a sulfosuccinate available from Henkel/Cospha, anionic HAMPOSYL L-30, a sarcosinate available from Hampshire Chemical, Lexington, Mass., and a saponin, a high molecular weight glycoside comprising a sugar part linked to a triterpene or steroid aglycone, such as that produced from quillaja bark and marketed by Sigma Chemical Company, St. Louis, Mo. Related information is provided in U.S. Pat. No. 6,350,711 issued to Potts et al., herein incorporated by reference.

Further systems for modification of menses are given in U.S. Pat. No. 6,060,636 issued to Yahiaoui et al., herein incorporated by reference, which discloses a treatment applied to an absorbent article that alters the viscoelastic properties of menses and enhances its wicking and distribution throughout the absorbent structure. One such menses modifier is an alkyl polyglycoside, particularly those having 8 to 10 carbon atoms in the alkyl chain. When applied so as to provide an amount of about 0.1 to about 5.0% solids add-on based on the weight of the dry nonwoven web, rapid fluid wicking and distribution may be obtained.

The use of enzymes to modify the viscous or viscoelastic properties of body fluids is disclosed in U.S. patent application Ser. No. 10/837,133, “Absorbent Products with a Linked Enzyme Treatment,” filed Apr. 30, 2004 by K. Schroeder et al. (published as US20050256471A1), herein incorporated by reference (see also WO2005110503A1). Gelling the fluid further modifies the properties of the fluids (e.g., for low viscosity, thin menses fluid or in liners for light thin fluid).

Structural modifications to pads may also be used to tailor the intake and absorbent properties of the pads for various types of menses. Selection of suitable body side liner materials, body side liner treatments, and other components of the article may result in articles well suited for particular fluid types and flow characteristics. See, for example, U.S. Pat. No. 6,627,789 issued to VanDenBogart et al. and U.S. Pat. No. 6,348,253 issued to Daley et al., both of which are herein incorporated by reference.

Appendix A provides test data illustrating different performance of feminine care products as a function of fluid with varied viscoelastic properties.

Exemplary correlations between the vaginal discharge data and the product attributes are shown in Table 1 below. Table 1 provides various examples of information collected from the consumer 102 to direct and aid product selection. Product selection is tailored based on fluid and flow characteristics as well as characteristics of the consumer's age/biological life stage and body. Using body characteristics to direct product selection provides improved fit, reduced leakage, and comfort for the consumer 102. Other questions (not shown in Table 1) may be directed to the symptoms or status of menopause or perimenopause of the consumer 102.

TABLE 1
Exemplary Predefined Correlations between
Vaginal Discharge Data, Characteristics of Age/Life Stage
and Body, and Product Attributes.

| Question/Measurement | Needs | Solution |
|---|---|---|
| Does your fluid have | Pad to address high | Pad containing |
| a stringy consistency | viscoelastic fluid | viscoelastic reduction |
| when you wipe? | (menses). | (mucin modifier) |
| | | applications or other |
| | | fluid modifiers, or |
| | | pads with high void |
| | | space and low |
| | | permeable intake |
| | | systems for highly |
| | | viscous fluids. |
| Do you currently take | Pad to address | Pads with tailored |
| birth control pills | modified flow and | absorbent properties, |
| (or other hormone | viscoelastic | etc. E.g., pad with |
| therapy)? | properties; Pad for | less absorbent |
| | low flow amounts and | saturation capacity or |
| | rate. | void volume that is |
| | | flexible to provide |
| | | better contact to the |
| | | body, a source of |
| | | fluid exit, and that |
| | | contain mucin |
| | | modifiers and low |
| | | permeable body side |
| | | liners. |
| How long does it take | Pad to address high | High flow: Pad with |
| to fill/saturate your | flow (short wear | high capacity or high |
| pad? | times) vs. low flow | void volume intake |
| | (long wear times) | system and/or |
| | (e.g., maxis vs. | increased amount of |
| | ultrathins). | SAM for storage or |
| | | retention capacity; |
| | | Low flow: Ultra thin |
| | | pad with lower |
| | | capacity and/or odor |
| | | control. |
| Do you experience | Pad to handle gushes. | Pad with high void |
| gushes? | | volume, gasketing |
| | | feature, higher basis |
| | | weight, or BCW intake |
| | | system or flaps on the |
| | | sides, front and/or |
| | | back of pad. Pad with |
| | | fluid thickener. |
| Where does your pad | Side: pad that | Side: pad with wings, |
| most frequently leak? | mitigates side | side barriers or |
| | leakage. | gasketing features; |
| | Back: pad that | pad with increased |
| | mitigates back | local saturation |
| | leakage. | capacity or increased |
| | | MD fluid distribution. |
| | | Back: Pad with |
| | | features such as |
| | | gluteal-fold fit |
| | | features or increased |
| | | back panty/body |
| | | coverage or more |
| | | flexible pad to |
| | | provide intimate |
| | | contact with body to |
| | | intercept fluid. |
| What kind of | If thong wearer: | Thong-compatible |
| underwear do you | Comfortable | liners; ultrathin pads |
| usually wear? | protection that fits | with ultra-conformable |
| | thong underwear. | absorbent structure. |
| Does your fluid | Product that absorbs | Product with increase |
| appear to be thin or | and locks in less | SAM or gradient pore |
| blood-like? | viscous, more | structure for |
| | Newtonian-like | increased fluid |
| | fluids. | distribution into the |
| | | pad away from the |
| | | body. |
| Does your fluid | Product that handles | Pad with mucin |
| appear to be thick? | fluid with higher | modifiers or lysing |
| | viscoelasticity and | agents and highly |
| | higher mucin content. | permeable body side |
| | | liner and intake |
| | | system. |
| If you wear tampons, | Teen tampon that | Tampon with smaller |
| what is your age? | provides comfortable | applicator and pledget |
| | insertion and wear by | (e.g., smaller amount |
| | offering a better fit | of absorbent) |
| | in a teen's lower | |
| | volume vagina. | |
| Input height and | Pad that mitigates | Pad with features such |
| weight to calculate | back leakage, | as gluteal-fold fit |
| or provide user's | especially during | features or increased |
| body mass index (BMI) | nighttime wear. | back panty/body |
| (e.g., via a chart or | | coverage or more |
| table). | | flexible pad to |
| | | provide intimate |
| | | contact with body to |
| | | intercept fluid. |

A back pad with features such as gluteal-fold fit or other features suitable for use with thong-style underwear is described in W00072790A1, “ABSORBENT ARTICLE FOR USE IN THONG UNDERWEAR,” published Dec. 7, 2000. Increased back panty/body coverage and methods for customizing fit are disclosed in commonly owned, co-pending U.S. patent application Ser. No. 10/750,404, entitled “CUSTOMIZABLE ABSORBENT ARTICLE WITH EXTENSIBLE LAYERS,” filed Dec. 30, 2003 by Price et al. (published as US20050148981A1), herein incorporated by reference.

The vaginal discharge data 116 of the consumer 102 may be obtained directly from the consumer 102, or from via any means for obtaining the data (e.g., history) such as from an obstetrician or gynecologist. Aspects of the invention are operable with any means for obtaining the vaginal discharge data 116 from the consumer 102. A kiosk, doctor's office test, home tests (e.g., pH testing, hormonal testing), web site, telephone, wireless device (e.g., PDA, cellular telephone), and the like constitute the means for obtaining the vaginal discharge data 116 from the consumer 102. For example, the consumer 102 may input the vaginal discharge data 116 into the system 104, or the system 104 may infer or determine the vaginal discharge data 116 based on information supplied by the consumer 102 or other entity (e.g., doctor, hospital, or laboratory). The consumer 102 may determine the actual rheological properties through physical testing, measurements, observation, sampling, or the like. Alternatively or in addition, aspects of the invention infer, calculate, or otherwise determine the rheological properties based on the personal information obtained from the customer. By way of example, a method for obtaining cervicovaginal fluids from which viscoelastic properties may be measured is discussed by E. R. Boskey et al. in “A Self-Sampling Method to Obtain Large Volumes of Undiluted Cervicovaginal Secretions,” Sexually Transmitted Diseases, 30(2):107-109, February 2003. The use of a ROVUMETER (Recipe Pharmaceuticals, Munich, Germany) to obtain such fluids is also discussed by A. M. Flynn et al. in “Volumetric Self-Sampling of Cervicovaginal Fluid To Determine Potential Fertility: a Multicentre Preeffectiveness Study of the Rovumeter™,” Human Reproduction, 12(8):1826-1831, 1997. Testing of properties may be conducted by commercial laboratories or by self-testing using known methods and devices such as viscosity cups in which fluid drains through an orifice in a cup, with drainage time for a given volume being related to viscosity. An example of a viscosity cup is the Elcometer 2210 Zahn Viscosity Cup marketed by Elcometer Instruments Ltd. (Manchester, England). In addition to viscosity cups, specialized tampons may be used as a vaginal sampling device.

The vaginal discharge data 116 of the consumer 102 describes the composition and/or properties of the vaginal discharge of the consumer 102 including, but not limited to, one or more of the following: a biological property and a rheological property. Exemplary biological properties include one or more of the following: flow rate (e.g., volume per unit of time), red blood cell count, white blood cell count, hemoglobin, hematocrit, total protein, albumin, fibrinogen, fibrin degradation products, phospholipids, mucin content, and qualitative viscosity. Exemplary rheological properties define the deformation and flow of matter including, for example, one or more of the following related to vaginal discharge (e.g., venous blood and menses): elasticity, viscosity, viscoelasticity, and spinnbarkeit (e.g., the stringiness or extensional viscosity of cervical mucus, menses, and/or other related fluids). Rheological properties may also be defined via observations of appearance (e.g., thick, thin, stringy) to relate descriptively to viscoelastic properties.

As shown in Table 1 above, the vaginal discharge data 116 and life event/stage of the consumer 102 may also include one or more of the following: parity, birth control use, ethnicity, ovulation stage, which ovaries are functioning, odor, volume, flow, color, basal temperature, mucoviscosity, and pregnancy. Exemplary ovulation stages include irregular ovulation due to puberty or a medical condition, no ovulation due to hormonal birth control or a medical condition, regular ovulation, peri-menopausal irregular ovulation, and no ovulation due to menopause.

The vaginal discharge data 116 of the consumer 102 is used to determine the attributes of the personal care products that are appropriate for the consumer 102 based on the predefined correlations 118 (e.g., see Table 1 above). This determination may be performed by a human or a computing device. In one example, the processor 108 is configured to execute computer-executable instructions for identifying one or more of the attributes of the feminine care products corresponding to the vaginal discharge data 116 of the consumer 102 stored in the memory area 106 based on the predefined correlations 118 stored in the memory area 106. The processor 108 is further configured to execute computer-executable instructions for providing one or more of the identified attributes to the consumer 102 for use in selecting one of the feminine care products. In another embodiment, recommendations are given to the consumer 102 about particular products that embody the identified attributes. The processor 108 may be further configured to determine the vaginal discharge data 116 of the consumer 102 rather than the consumer 102 providing the vaginal discharge data 116. For example, the processor 108 may be configured to determine the vaginal discharge data 116 of the consumer 102 based on body/age/life stage characteristics.

In another embodiment, body shape data obtained from the consumer 102 may also be used to determine the attributes of the personal care products that are appropriate for the consumer 102. For example, body shape data may be characterized in terms of two or more measurements such as hip-to-waist ratio, hip-to-rise ratio, rise-to-thigh circumference ratio, and the like. In another example, body shape data may be characterized in terms of clothing cuts such “for fuller hips,” “slim fit,” or the like. In yet another example, body shape data may be characterized in terms of body shape classifications such as “pear shape,” “apple shape,” “hourglass shape,” or the like.

Alternatively or in addition, the predefined correlations 118 may be updated or otherwise modified based on feedback data or other factors. Exemplary factors include, but are not limited to, purchasing habits of one or more of the consumers and feedback from the consumer 102. The feedback from the consumer 102 may relate to any aspect of the consumer 102 interaction with the system 104 (e.g., the information input process, the overall experience, the attributes identified, the products recommendations, and the products themselves). In one embodiment, the feedback from the consumer 102 may be obtained by a subsequent contact with the consumer 102 (e.g., via email or telephone). For example, a website for collecting the vaginal discharge data 116 from the consumer 102 may also ask the consumer 102 for an email address or telephone number. A subsequent email or telephone call to the consumer 102 may be used to obtain the feedback from the consumer 102.

Exemplary feedback data includes information about the pharmaceutical use of reproductive hormones, age, body dimensions, body mass index, vaginal size, and the use of dietary supplements (e.g., herbal products, phytoestrogens).

In one embodiment, the predefined correlations 118 are updated by the processor 108 configured to execute computer-executable instructions for receiving a product selection from the consumer 102 and modifying the predefined correlations 118 stored in the memory area 106 based on the received product selection. For example, the system 104 may determine the frequency that consumers with vaginal discharge having a particular biological or rheological property chose a particular product. The predefined correlations 118 are then updated with this determination to provide improved recommendations to future consumers.

In general, the processor 108 and the memory area 106 of system 104 may constitute or be part of a computing device. Aspects of the invention are operable with any form of computer or computing device known in the art. The consumer 102 may enter commands and information into the computing device through input devices or user interface selection devices well known in the art such as a keyboard and a pointing device (e.g., a mouse, trackball, pen, or touch pad). Other input devices (not shown) may be connected to the computing device. The computing device typically has at least some form of computer readable media (e.g., memory area 106). Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. The computing device may operate in networked or distributed computing environments using logical connections to one or more remote computers in which tasks may be performed by the remote computers.

Although embodiments of the invention are described in connection with an exemplary computing system environment, one or more aspects of the invention are operational with non-computer components as well as numerous other general purpose or special purpose computing system environments or configurations. The computing system environment described herein is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

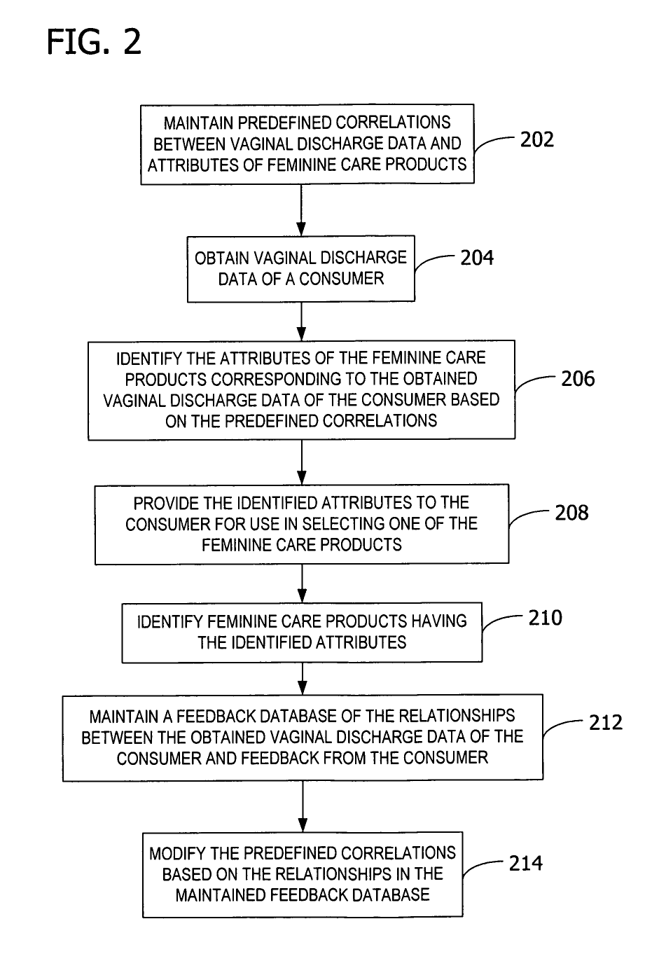

Referring next to FIG. 2, a flow chart illustrates exemplary operation of one method of the invention. The method maintains predefined correlations between vaginal discharge data and attributes of feminine care products at 202, obtains vaginal discharge data (or biological life stage/life event history) of the consumer regarding a biological property and a rheological property of vaginal discharge (e.g., menses) from the consumer at 204, and identifies one or more of the attributes of the feminine care products corresponding to the obtained vaginal discharge data of the consumer based on the maintained predefined correlations at 206. The vaginal discharge data may be received directly from the consumer or other entity, or inferred or otherwise calculated. Identifying the product attributes includes, for example, identifying the product attributes based on biological life stage and hormonal changes of the consumer. One or more of the identified attributes are provided to the consumer for use in selecting one of the feminine care products at 208. Alternatively or in addition, the method identifies feminine care products having the identified attributes at 210. The method further maintains a feedback database of the relationships between the obtained vaginal discharge data of the consumer and feedback data from the consumer (e.g., product selections) at 212 and modifies the predefined correlations based on the relationships in the maintained feedback database at 214.

In one embodiment, one or more computer-readable media have computer-executable instructions for performing one or more of the operations illustrated in FIG. 2. A processor in conjunction with a memory area such as memory area 106 shown in FIG. 1 executes the computer-executable instructions to implement aspects of the invention. Generally, computer-executable instructions include, but are not limited to, routines, programs, objects, components, and data structures that perform particular tasks or implement particular abstract data types. Program modules may be located in both local and remote computer storage media including memory storage devices.

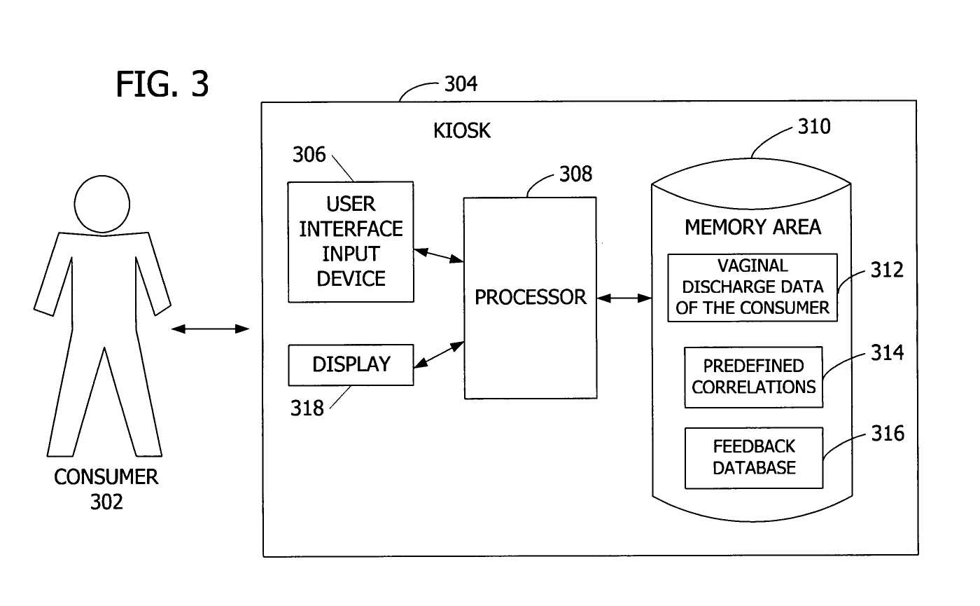

Referring next to FIG. 3, an exemplary embodiment of the invention illustrates a consumer 302 interacting with a kiosk 304 to obtain a product recommendation. The kiosk 304 includes a user interface input device 306, a processor 308, a memory area 310, and a display 318. The memory area 310 stores vaginal discharge data 312 of the consumer 302, predefined correlations 314, and a feedback database 316. The user interface input device 306 receives from the consumer 302 a request for a product recommendation along with vaginal discharge data of the consumer 302 in one embodiment. In another embodiment, the vaginal discharge data 312 of the consumer 302 is inferred or calculated from other data input by the consumer 302 via the user interface input device 306. The memory area 310 stores the vaginal discharge data 312 of the consumer 302. The processor 308 in the kiosk 304 performs operations such as those illustrated in FIG. 2. The display 318 in the kiosk 304 displays to the consumer 302 the attributes of the products corresponding to the vaginal discharge data 312 of the consumer 302. In one embodiment, particular products having the attributes are identified to the consumer 302. With this information, the consumer 302 may make a purchase decision regarding the personal care product. In general, the consumer 302 may request and receive a product recommendation for a single product or for a system of products based on the varying rheological properties throughout the consumer's menstrual cycle.

In FIG. 3, the user interface input device 306 comprises a touch screen device capable of also functioning as the display 318. That is, the user interface input device 306 may function in such an embodiment as an input device and an output device.

In one embodiment, the kiosk 304 is local to the consumer 302 while the functionality of the processor 308 is located remotely from the interface and/or consumer 302. For example, the functionality of the processor 308 may be performed by the processor 308, and/or a human agent or the like located in another country. Alternatively or in addition, the functionality of the processor 308 may be performed by an intelligent agent and/or a live agent or the like.

The following examples further illustrate embodiments of the invention. Hardware, software, firmware, computer-executable components, computer-executable instructions, and/or the elements of FIGS. 1-3 constitute means for maintaining the predefined correlations between vaginal discharge data and attributes of feminine care products, means for obtaining the vaginal discharge data of the consumer 302 regarding a biological property and a rheological property of vaginal discharge from the consumer 302, means for identifying one or more of the attributes of the feminine care products corresponding to the obtained vaginal discharge data of the consumer 302 based on the maintained predefined correlations, and means for providing one or more of the identified attributes to the consumer 302 for use in selecting one of the feminine care products or a system of products for the entire menstrual cycle.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### APPENDIX A

The following test data illustrates different performance of feminine care products as a function of fluid with varied viscoelastic properties. The fluid acquisition results are illustrated in graph 1, and wicking results are shown in graph 2. Testing was done with menses simulants having varying levels of mucin present (X% mucin is less than Y% mucin in graph 1 and graph 2). The percentage of mucin is a factor in viscoelasticity, permeability, acquisition rate, and wicking. In general, vaginal discharge with some percentage of mucin may be expected to typically yield slow acquisition and low uptake/loading/wicking values.

[image]

[image]

What is claimed is:

1. A method comprising:
maintaining predefined correlations between vaginal discharge data and attributes of feminine care products;
obtaining vaginal discharge data of a consumer regarding a biological property and a rheological property of vaginal discharge from the consumer;
identifying one or more of the attributes of the feminine care products corresponding to the obtained vaginal discharge data of the consumer based on the maintained predefined correlations; and
providing one or more of the identified attributes to the consumer for use in selecting one of the feminine care products.

2. The method of claim 1, wherein identifying the one or more of the attributes comprises identifying the one or more of the attributes based on one or more of the following: biological life stage, hormonal changes, body mass index, age, and body shape.

3. The method of claim 1, wherein the vaginal discharge from the consumer comprises menses.

4. The method of claim 1, wherein obtaining the vaginal discharge data of the consumer comprises obtaining the vaginal discharge data from the consumer.

5. The method of claim 1, wherein obtaining the vaginal discharge data of the consumer comprises determining the vaginal discharge data of the consumer.

6. The method of claim 1, further comprising identifying feminine care products having the identified attributes.

7. The method of claim 1, further comprising:
receiving feedback from the consumer;
maintaining a feedback database of the relationships between the obtained vaginal discharge data of the consumer and the received feedback; and
modifying the predefined correlations based on the relationships in the maintained feedback database.

8. The method of claim 1, wherein one or more computer-readable media have computer-executable instructions for performing said maintaining the predefined correlations between the vaginal discharge data and the attributes of the feminine care products and said identifying the one or more of the attributes of the feminine care products corresponding to the obtained vaginal discharge data of the consumer based on the maintained predefined correlations.

9. The method of claim 1, wherein providing the one or more of the identified attributes to the consumer comprises providing the one or more of the identified attributes to the consumer for use in selecting a plurality of feminine care products for use throughout the menstrual cycle of the consumer.

10. The method of claim 1, further comprising obtaining body shape data from the consumer, wherein identifying the one or more of the attributes of the feminine care products comprises identifying one or more of the attributes of the feminine care products corresponding to the obtained body shape data.

11. A system comprising:
a memory area storing predefined correlations between vaginal discharge data and attributes of feminine care products, said memory area further storing vaginal discharge data of a consumer regarding a biological property and a rheological property of vaginal discharge from the consumer; and
a processor configured to execute computer-executable instructions for:
identifying one or more of the attributes of the feminine care products corresponding to the vaginal discharge data of the consumer stored in the memory area based on the predefined correlations stored in the memory area;
providing one or more of the identified attributes to the consumer for use in selecting one of the feminine care products;
receiving feedback data from the consumer;
determining one or more relationships between the vaginal discharge data of the consumer and the received feedback data; and
modifying the predefined correlations stored in the memory area based on the determined relationships.

12. The system of claim 11, further comprising one or more of the following: means for maintaining predefined correlations between vaginal discharge data and attributes of feminine care products, means for obtaining vaginal discharge data of a consumer regarding a biological property and a rheological property of vaginal discharge from the consumer, means for identifying one or more of the attributes of the feminine care products corresponding to the obtained vaginal discharge data of the consumer based on the maintained predefined correlations, and means for providing one or more of the identified attributes to the consumer for use in selecting one of the feminine care products.

13. The system of claim 11, wherein the processor is further configured to determine the vaginal discharge data of the consumer.

14. The system of claim 11, wherein the processor is further configured to determine the vaginal discharge data of the consumer based on one or more of the following: body characteristics, age, and life stage characteristics.

15. The system of claim 11, wherein the attributes of the feminine care products comprise one or more of the following: materials, absorbent system design, additives, shape, absorbency, pad structure, resiliency, flexibility, thickness, length, width, and presence of gasketing features, embossing, and apertures.

16. The system of claim 11, further comprising one or more computer-readable media having computer-executable components comprising:
a database component for maintaining predefined correlations between vaginal discharge data and attributes of feminine care products;
an interface component for obtaining vaginal discharge data of a consumer regarding a biological property and a rheological property of vaginal discharge from the consumer;
a recommendation component for identifying one or more of the attributes of the feminine care products corresponding to the obtained vaginal discharge data of the consumer based on the maintained predefined correlations, wherein the interface component further provides one or more of the identified attributes to the consumer for use in selecting one of the feminine care products.

17. The system of claim 11, wherein the vaginal discharge data comprises one or more of the following: a value for a biological property of the vaginal discharge of the consumer and a value for a rheological property of the vaginal discharge of the consumer.

18. The system of claim 11, wherein the biological property comprises one or more of the following: flow rate, red blood cell count, white blood cell count, hemoglobin, hematocrit, total protein, albumin, fibrinogen, fibrin degradation products, phospholipids, qualitative viscosity, mucin level, and tissue presence.

19. The system of claim 11, wherein the rheological property comprises one or more of the following: elasticity, viscosity, and spinnbarkeit.

20. The system of claim 11, wherein the feedback data includes one or more of the following: age, body dimensions, body mass index, and vaginal size.

21. The system of claim 11, wherein the feedback data includes information about the pharmaceutical use of reproductive hormones.

22. The system of claim 11, wherein the vaginal discharge data comprises one or more of the following: fluid appearance, fluid description, and flow amount.
